(19) United States
(12) Patent Application Publication
(10) Pub. No.: US 2004/0096535 A1
(43) Pub. Date: May 20, 2004

(54) Compression molding apparatus having replaceable mold inserts

(76) Inventors: Robert W. Hudecek, Geneva, IL (US); William E. Grisch, Aurora, IL (US)

Correspondence Address: Bell, Boyd & Lloyd LLC, P.O. Box 1135, Chicago, IL, 60690-1135, US

(21) Appl. No.: 10/295,178

(22) Filed: Nov. 15, 2002

(51) Int. Cl. B29C 43/36; B29C 43/50; B29C 33/46

(52) U.S. Cl. 425/193; 425/195; 249/102; 425/408; 425/422; 425/437

(57) ABSTRACT

A compression molding apparatus including a top mold base, a top mold insert removably mounted in the top mold base, a bottom mold base, and a bottom mold insert removably mounted in the bottom mold base. The top and the bottom mold bases are pressed together to compress a molding material inserted between the top and the bottom mold inserts to compression mold a desired part. The top and bottom mold inserts are removed and replaced with different top and bottom mold inserts to compression mold a different part.

### BACKGROUND OF THE INVENTION

Compression molding apparatus are currently used to manufacture thermoset and thermosplastic products such as entry doors, wall panels, cabinetry, backboards, small vessel hulls and various other products. The conventional compression molding system includes a pair of co-acting or complementary solid steel machined mold plates suitably mounted to a hydraulic press. A suitable molding material is placed between the mold plates (on the lower mold plate) and compressed under heat to form the desired mold part. The molding material is usually a composite material. In one type of compression molding apparatus, the molding material is in the form of a sheet. This type of apparatus is often referred to as a compression sheet molding apparatus.

One problem with such known compression molding apparatus is that each pair of mold plates are dedicated or unique to one specific product. In other words, a pair of mold plates can be used to mold a particular product or part only, and cannot be used for making another part having a different shape, even if the difference is relatively minor. Once such mold plates have been machined or produced, the mold plates cannot be used to mold any other parts. This significantly contributes to the overall cost of manufacturing compression molded products, since new mold plates must be fabricated to produce each product, even if there is only a minor variation between the product lines.

Further, because the known molding plates of compression molding apparatus are generally made or machined from solid steel and are relatively large, they are extremely heavy and are relatively expensive to fabricate. These plates are also difficult to transport from the place of fabrication to the location of the compression molding apparatus, which adds to the overall cost. At the location where the compression molding process is conducted, the plates are difficult and time consuming to move due to their size and weight. Also, businesses that manufacture compression molded products typically produce many different molded products. Consequently, these businesses need large storage areas to store all the mold plates used in making these different products, especially since each mold must be saved for potential subsequent use.

There is a need for a compression molding apparatus which employs mold plates that are relatively less expensive to manufacture, are easy to change, and are less burdensome to move and store.

### SUMMARY OF THE INVENTION

The present invention overcomes these problems by providing a compression molding apparatus having removable, replaceable and interchangeable mold inserts. The removability, replaceability and interchangeability of the mold inserts provides several advantages. The mold bases which are adapted to receive the mold inserts do not need to be refabricated for each different product to be made by the compression molding apparatus. Additionally the mold bases do not need to be removed from the hydraulic press for each different product made. This also substantially reduces the physical storage area previously necessary to store the molds. These features saves substantial expense including the related expenses relating to the fabrication of the mold bases, delivery of the mold bases and manpower expenses for changing the mold bases. These features also reduce downtime of the presses while the mold bases are being changed in the compression molding process.

One embodiment of the present invention provides a compression molding apparatus for producing a compression molded product or part. The apparatus generally includes (i) a first or top mold base having a receiving area defined by a receiving surface, (ii) a first or top mold insert sized and adapted to be removably attached to the first or top mold base in the receiving area adjacent to the receiving surface, (iii) a second or bottom mold base having a receiving area defined by a receiving surface, and (iv) a second or bottom mold insert sized and adapted to be removably attached to the second or bottom mold base in the receiving area adjacent to the receiving surface. The top and the bottom mold bases are each respectively mounted to a hydraulic press. The hydraulic press causes the top mold base (and top mold insert mounted in the top mold base) to move downwardly onto the bottom mold base (and bottom mold insert mounted in the bottom mold base) to compress molding material inserted between the opposing surfaces of the top and bottom mold inserts (which is preferably suitably placed on the top or mold surface of the bottom mold insert) to mold the desired part or product. The present invention provides for multiple different pairs of coacting top and bottom mold inserts to be removably received (i.e., each pair one at a time) to make different parts. To make different parts, the mold inserts are replaced and the mold bases remain stationary and do not need to be removed from the press. This saves substantial time and effort in changing the molds on a press to manufacture another compression molded product. It should be appreciated that in one embodiment, the molding material is in the form of a sheet which is molded by a compression sheet molding apparatus. It should also be appreciated that while the present invention is primarily referred to herein in respect to a top and bottom mold base, other arrangements are in accordance with the present invention such as side by side mold base arrangements.

In one presently preferred embodiment of the present invention, the attachment surface of the top mold insert includes a lock or a key that is respectively complementary to a key or a lock provided on the receiving surface of the top mold base. The lock and key facilitate the alignment of the top mold insert to the top mold base during the attachment process and also enable only the matching top mold insert to be attached to the top mold base.

Similarly, in one presently preferred embodiment of the present invention, a key or a lock is formed on the receiving surface of the bottom mold base and a complementary or co-acting lock or a key is formed on the attachment surface of the bottom mold insert facing the mold base. The lock and key facilitate the alignment of the bottom mold insert to the bottom mold base and also enable only the matching bottom mold insert to be attached to the bottom mold base.

The compression molding apparatus in accordance with one presently preferred embodiment of the present invention includes suitable stop pads extending along the periphery of one or both of the top and the bottom mold bases. The stop pads absorb the shock from the force of the top mold base being pressed against the bottom mold base, and also maintain a predefined distance between the top and the bottom mold inserts, such that the amount of compression used to form each part is consistent and such that each part is formed of a consistent desired thickness.

In one presently preferred embodiment of the present invention, a plurality of heel blocks are attached to and extend along the top mold base on the inside of a wall or ridge that defines and surrounds the top mold insert receiving area. The heel blocks are positioned to engage the bottom mold insert to ensure alignment of the top mold insert with the bottom mold insert when the top mold base is pressed against the bottom mold base. In an alternative embodiment, the heel blocks are attached to the bottom mold base and engage the top mold insert to ensure alignment of the top and bottom mold inserts when the top mold base is pressed against the bottom mold base. It should also be appreciated that the mold bases could both be moved together or the bottom mold base could be moved against the top mold base in accordance with the present invention. This is all referred to herein as being pressed together.

The top and the bottom mold inserts in one presently preferred embodiment of the present invention each include at least one steam channel which extends laterally and circuitously through the mold insert for distributing heat in the mold inserts which suitably heats the mold inserts and thus the composite molding material such as composite sheet molding material during the molding process. Each mold insert has at least one has a steam input or input port for each steam channel. The input port is positioned on the attachment surface of its corresponding mold insert to facilitate fluid connection to a steam outlet or outlet port which is formed in the receiving surface of the respective mold base. The steam channels in the mold inserts also include a steam output or outlet port which is also positioned on the attachment surface to facilitate connection to a steam inlet or inlet port which is formed in the receiving surface of the respective mold base. The steam circulates through the steam channels in the mold inserts and the steel material of the inserts transfer heat to the material being molded during the molding process to form the part or product under the desired amount of compression and heat. In one embodiment, the steam also travels through the mold bases to heat the molding material as discussed below. It should be appreciated that alternative embodiments of the present invention do not include heated bases or inserts. In such embodiments, the part is compression molded without the use of heat.

In one alternative embodiment of the present invention, the top and bottom mold inserts are respectively made slightly smaller then the respective mold insert receiving areas in the top and bottom bases. In this embodiment, the steam and more specifically the heat generated from the steam causes the steel mold inserts to thermally expand to further facilitate the secure alignment within the respective receiving areas.

In accordance with one presently preferred embodiment of the present invention, the mold bases and mold inserts also include a plurality of air communication lines which extend laterally through the top and the bottom mold bases and inserts. The air lines in the mold bases are connected to a plurality of air apertures or outlets defined in the mold insert receiving surfaces of the mold bases. When the mold inserts are mounted in the mold insert receiving areas of their respective top and bottom mold bases, certain of the air holes are employed by the air inlets, inlet ports, or connectors formed at suitable locations or positions in the mold inserts. These locations or positions are preferably based on the shape or pattern of the part to be compression molded by the mold inserts. These locations are typically at suitable structural points. These air inlets are connected to the fluid airlines or channels in the mold inserts to direct pressurized air to at least one and preferably a plurality of corresponding air poppets which are suitably embedded in the mold inserts. The air poppets are operable to extend from or protrude out of the mold surface (or an adjacent surface) of the mold inserts on which the molded part is formed to separate the molded part from the mold inserts during the part removal process at the end of the compression molding process. In one preferred embodiment, the mold bases each have or define a series of spaced apart air apertures, or outlets in the receiving areas or surfaces which are positioned to be used by different inserts for making different parts. This reduces the need to create circuitous or overly circuitous air channels in the mold inserts and thus reduces the machining (and thus cost) of the different removable mold inserts used in conjunction with the single mold base.

In one presently preferred embodiment of the present invention, the top and the bottom mold inserts are mounted to their respective mold bases by attaching a plurality of fasteners such as bolts through a plurality of fastening through holes or fastening apertures formed along a periphery of the mold inserts and extending transversely through the mold inserts. The through holes or apertures are preferably countersunk at the surface of the mold insert opposite the attachment surface so that the heads of the bolts do not protrude from this surface. Each of the mold bases have a plurality of corresponding threaded receiving holes for receiving the bolts and facilitating securement of the mold inserts to the respective mold bases.

In one embodiment of the present invention, the bottom mold insert includes a plurality of additional threaded through holes or mounting apertures formed along the periphery of the bottom and extending transversely through the bottom mold insert. The threaded holes are used to detach and raise the bottom mold insert from the mold base by threading a mounting or attachment member such as bolt through the threaded holes and against the surfaces of the mold base. The bolts engage the surface of the bottom mold base to raise and thus detach the mold insert (which due to gravity remains attached to the mold base even after the mounting bolts have been removed) from the mold insert receiving area of the bottom mold base. This arrangement, if necessary, may also be employed in the top mold insert and top mold base for further facilitating removal of the top mold insert from the top mold base. For instance, this arrangement may be employed if gravity does not cause the top insert to move downwardly out of the receiving area of the top mold base as the fasteners are loosened. It should also be appreciated that in an alternative embodiment of the present invention, the fastening apertures and mounting apertures are combined. In this embodiment, the fasteners are removed and suitable (i.e., longer) detachment members such as bolts are inserted into the apertures to raise, separate and or remove the bottom mold insert from the bottom mold base.

In one alternative embodiment of the present invention, suitable guide members which maybe used to attach or guide the top and bottom inserts respectively into the top and bottom mold bases during the installation of the mold inserts in the mold bases. Such guides could be removably attached to the mold inserts or the mold bases.

Accordingly, it should be appreciated that the present invention provides a method for compression molding a plurality of different parts. The method generally includes (i) providing a top mold base and mounting and attaching a top mold insert for one of the parts in the receiving area of the top mold base, and (ii) mounting and attaching a bottom mold insert for that part in a receiving area of a bottom mold base. A suitable molding material is placed between the top and the bottom mold inserts and compressed to compression mold the part by causing the top base to engage the bottom base. The compression molding process would be repeated a suitable number of times to make a number of the first parts.

To form a different part or product, the top and the bottom mold inserts are detached and removed from their respective top and bottom mold bases and a different pair of mold inserts suitable to form a different part or product are mounted in and attached to the respective mold bases. A suitable molding material is placed between these top and bottom mold inserts and compressed to compression mold the second part by causing the top base to engage the bottom base. The inserts may be aligned with the mold bases by the installers or as indicated above suitable guide members may be employed to guide the positioning of the inserts during the installation or mounting process. It should also be appreciated that a suitable pallet may be used to hold the top insert and facilitate the mounting of the top mold insert in the top mold base.

The method of the present invention also provides for the heating of the molding material necessary during the compression molding process by facilitating the channeling, communication and transfer of the steam or other suitable heating gas or fluid through the mold bases to the mold inserts that are removably attached to the mold bases. The steam is transferred or communicated to the channels described above which extend laterally through each of the top and the bottom mold inserts for transmitting heat to the material being molded. The aligned co-acting steam input port in the surface of the mold insert and steam outlet port of the mold base co-act to facilitate this transfer. The steam output port in the mold insert and the steam inlet in the mold base co-act to further facilitate this transfer. Accordingly, the steam circulates through the steam channel in the mold insert to transfer heat to the material being molded.

The present invention also provides a method for separating a molded part from a pair of co-acting mold inserts (that are removably attached to a pair of mold bases for compressing the molded part in a compression molding apparatus). The method includes directing compressed air through at least one air line that extends laterally through each of the mold bases and communicating the air to a plurality of air holes that extend to the mold insert receiving surface of the mold bases. When the mold inserts are mounted in the mold insert receiving area of their respective top and bottom mold bases, the mold inserts utilize certain of the plurality of air holes. It should be appreciated that the non-utilized air holes are blocked by the other portions of the mold insert to minimize decrease in the air pressure. Suitable air poppets are provided in the inserts and are mounted generally flush with the mold surface of the insert (i.e., opposite the attachment surface that contacts the receiving surface of the mold base) and are connected to the air lines. In operation, the air poppets protrude out of the surface to separate the molded part from the mold inserts when pressurized air is supplied to their corresponding air lines. It should thus be appreciated that the mold bases provide suitable air outlets for a plurality of different inserts such that the air poppets can be positioned in the most suitable places based on the desired design or pattern of the parts and that different mold inserts will utilize different air apertures or holes based on the design of the mold inserts which is in turn based on the design of the part to be compression molded.

It is therefore an advantage of the present invention to provide a compression molding apparatus having different pairs of mold inserts that can be relatively easily mounted to and removed from their corresponding mold bases to mold different parts, without moving, removing or replacing the mold bases themselves or detaching the mold bases from the press.

Another advantage of the present invention is to provide a compression molding apparatus having a lock and key arrangement provided between the mold base and the mold insert to assist in aligning and prevent misalignment of the mold insert and mold base.

Another advantage of the present invention is to provide a compression molding apparatus having fluid communication channels extending laterally through each of the top and the bottom mold inserts and mold bases to supply steam to the mold inserts respectively attached to mold base using the same steam inlets and outlets on the mold bases.

Yet another advantage of the present invention is to provide a compression molding apparatus having alignment members on one or more of the mold bases which engage the opposing mold inserts to ensure alignment of opposing mold inserts.

A further advantage of the present invention is to provide a compression molding apparatus having fluid communication lines that extend through the mold bases and different pairs of mold inserts to facilitate compressed air to air poppets which cause the separation of the molded part from the mold inserts.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE FIGURES

FIG. 1 is an exploded perspective view of a compression molding apparatus of one embodiment of the present invention illustrating the top mold base, the top mold insert, the bottom mold insert and the bottom mold base.

FIG. 2A is an exploded perspective view of the top mold base and insert and the bottom mold base and insert of the compression molding apparatus of FIG. 1.

FIG. 2B is a upside down perspective view of the top mold base and the top mold insert mounted in the top mold base of the compression molding apparatus of FIG. 1.

FIG. 2C is a perspective view of the bottom mold base and the bottom mold insert mounted in the bottom mode base of the compression molding apparatus of FIG. 1.

FIG. 2D is a perspective view of the compression molding apparatus of FIG. 1 in a molding or compressed position.

FIG. 3 is a partial sectional view of the compression molding apparatus of FIG. 2 taken substantially along line 3-3 of FIG. 2D with parts omitted for clarity and shown attached to a press (drawn in fragmentary).

FIG. 4 is a bottom plan view of a top mold base of the compression molding apparatus shown in FIG. 1.

FIG. 5 is a top plan view of a bottom mold base of the compression molding apparatus shown in FIG. 1.

FIG. 6A is a bottom plan view of a top mold insert of the compression molding apparatus of FIG. 1, shown mounted to the top mold base of FIG. 4.

FIG. 6B is a top perspective view of the top mold insert of FIG. 6A.

FIG. 7A is a top plan view of a bottom mold insert of the compression molding apparatus of FIG. 1, shown mounted to the bottom mold base of FIG. 5.

FIG. 7B is an upside down perspective view of the bottom mold insert of FIG. 7A.

FIG. 8A is a diagram illustrating one embodiment of a method for separating the top and the bottom mold inserts from their respective top and bottom mold bases.

FIG. 8B is a diagram illustrating one-embodiment of an alternative method for separating the top and the bottom mold inserts from their respective top and bottom mold bases.

FIG. 9 is a sectional view of the compression molding apparatus of FIG. 2 taken substantially along line 9-9 of FIG. 2D.

FIG. 10 is a sectional view of the top or the bottom mold insert taken substantially along line 10-10 of FIG. 6B or FIG. 7B.

FIG. 11 is a top plan view of the bottom mold insert being mounted to the bottom mold base as shown in FIG. 7A, with parts omitted for clarity and showing air lines extending through the bottom mold base in accordance with one embodiment of the present invention.

FIGS. 12A and 12B are sectional views of an air valve for separating the molded part from the mold inserts, in accordance with one embodiment of the present invention.

### DETAILED DESCRIPTION OF THE INVENTION

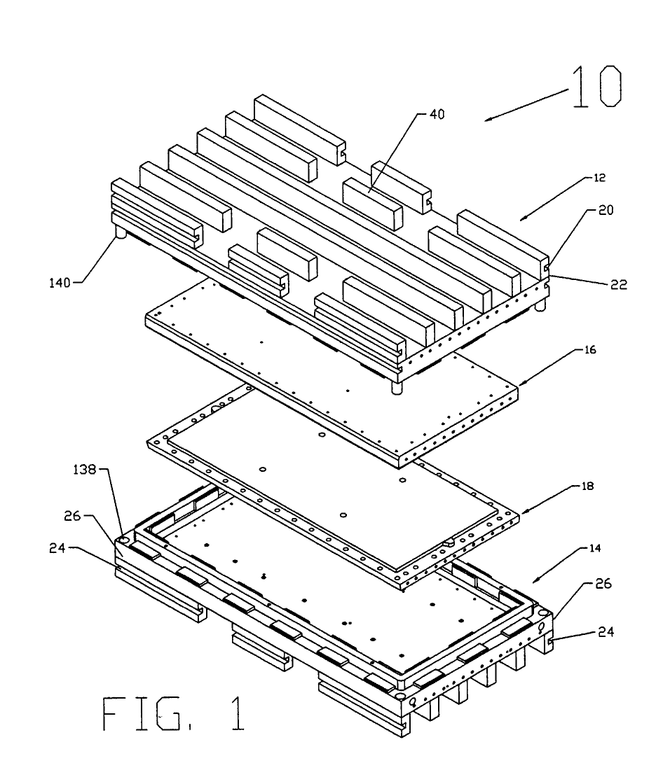

Referring now to the drawings, generally to FIGS. 1, 2A, 2B, 2C, 2D and 3, 4, 5, 6A, 6B, 7A, 7B, and 9, the compression molding apparatus 10 in accordance with one embodiment of the present invention includes a first or top mold base 12, a complimentary second or bottom mold base 14, a first or top mold insert 16 removably attached to the first or top mold base and a second or bottom mold insert 18 removably attached to the second or bottom mold base. For purposes of this application, the bases and inserts will be primarily referred to herein and illustrated as top and bottom inserts and bases. However, it should be appreciated that such terms are meant to include other arrangements such as side by side arrangements. It should also be appreciated that the invention is illustrated primarily in relation to a compression sheet molding apparatus, but that the present invention is not limited to molding products from sheets.

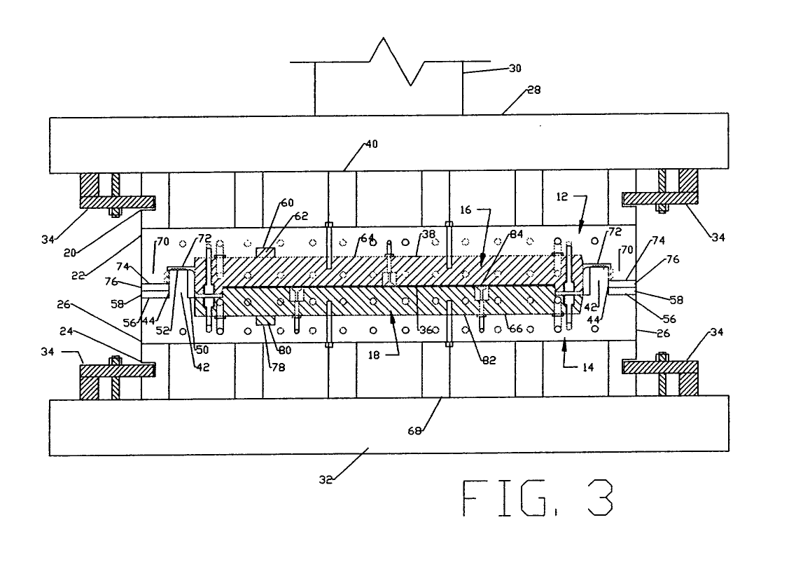

The top mold base 12 includes or defines slots 20 which extends along its longitudinal sides 22, and the bottom mold base 14 includes or defines slots 24 which extends along its longitudinal sides 26. The slots 20 facilitate the mounting of the top mold base 12 to a movable top platen 28 of a press 30 in a conventional manner, and the slots 24 facilitate the mounting of the bottom mold base 14 to a stationary bottom platen 32 of the press in a conventional manner as generally (shown in FIG. 3). A plurality of suitable conventional clamps 34 are provided at various points along the lengths of the slots 20 and 24 to facilitate mounting of the top and bottom mold bases 12 and 14 to the press 30 in a conventional manner for compression molding apparatus.

In operation, the press 30 lifts the top platen 28 upwardly and away from the bottom platen 32 to separate the top mold base 12 from the bottom mold base 14 and to allow a molding material such as a sheet of molding material to be placed on the bottom mold insert 18. When the press 30 brings the top platens 28 to the bottom platen 32, thus bringing the mold bases 12 and 14 together, the molding material between the top and bottom inserts 16 and 18 is compressed to form a molded part 36 (shown in FIG. 3). The types of material used in forming the molded part 36 may include thermoset materials such has polyester, vinyl esters, phenolics, etc., with fiberglass and inert fillers, for example. The molded part 36 may also be formed from thermoplastics including polypropylene, polyethylene, etc., with filled and unfilled fiberglass. It should be appreciated that the material could include a suitable pigment, catalyst and/or a UV inhibitor. Those skilled in the art will also recognize that other suitable materials and composites can also be used to form the molded part or product 36.

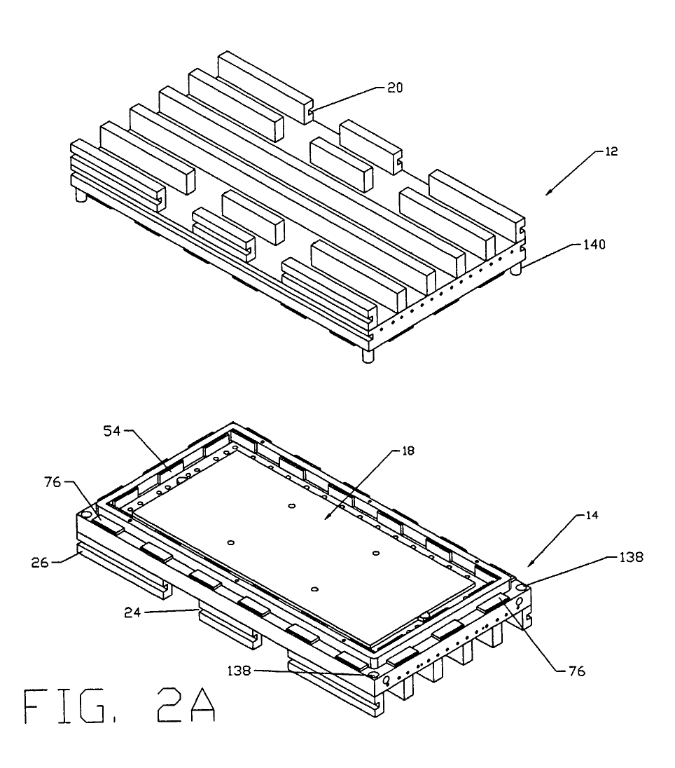

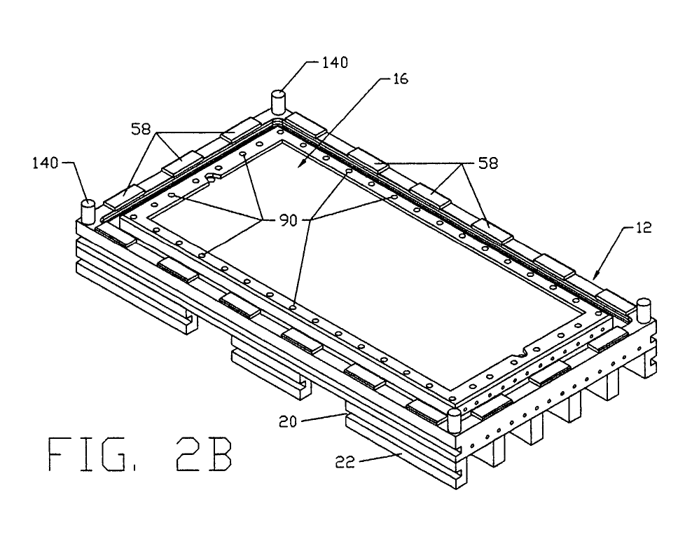

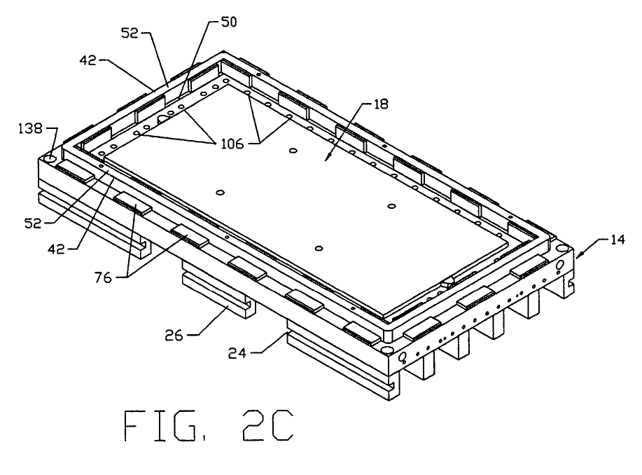

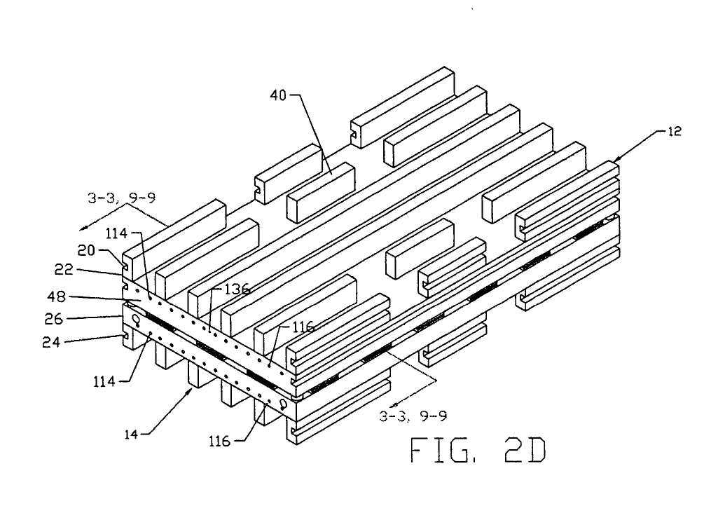

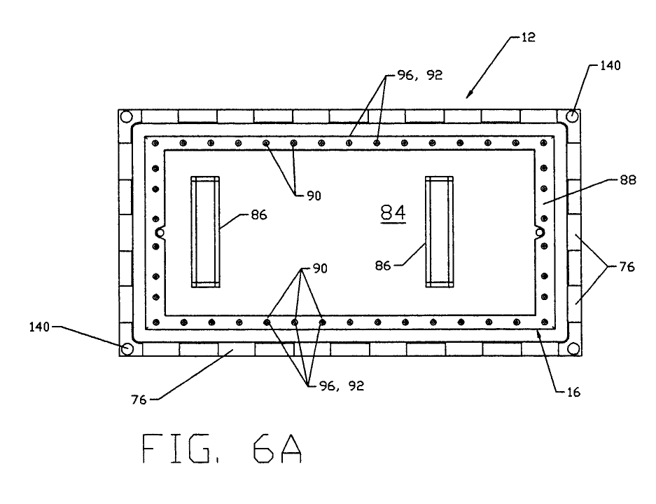

Turning now to FIG. 5, the bottom mold base 14 has and by an insert receiving area defined by a receiving surface 66 opposite an outside surface 68 (best shown in FIGS. 2 and 3) which comes in contact with the bottom platen 32 of the press 30 when the bottom mold base 14 is mounted to the bottom platen. The insert receiving surface 66 is bounded by a ridge 42 which further defines the insert receiving area and includes a pair of spaced-apart longitudinal sides 44 that extend generally parallel to the longitudinal sides 26 of the bottom mold base 14, and a pair of spaced-apart transverse sides 46 that extend generally parallel to transverse sides 48 of the bottom mold base 14. The ridge 42 includes an inner shelf 50 which is stepped down from a generally flat top 52 of the ridge 42 towards the insert receiving surface 66 along all its sides 44 and 46.

A plurality of generally flat heel blocks 54 are attached spaced along the shelf 50 of the ridge 42 to enable the sides of the top insert 16 to align itself within the ridge 42 by abutting against the heels block near plates, when the top and the bottom mold bases 12 and 14 are pressed together to form the molded part 36 (best shown in FIG. 3). The heel block near plates are preferably made from steel and attached to the ridge 42 by welding, bolting or other suitable manner or are machined in the mold base.

A ledge 56 is stepped down from the top 52 of the ridge 42 along all the sides 44 and 46 of the ridge and extends to the sides 26 and 48 of the bottom mold base 14. In one embodiment of the present invention, an elongated mold stop 58 is attached to the ledge 56 along each sides 26 and 48 of the bottom mold base 14, to maintain a predetermined space between the top and the bottom mold inserts 16 and 18 when the top mold base is pressed against the bottom mold base. Preferably, the mold stops 58 are made from steel and suitably attached or formed integral with the mold bases. Instead of one mold stop 58 extending substantially the length of its respective sides 26 and 48 of the ledge 56, a plurality of shorter stops 58 can be provided on each side or portion of the ledge.

In one embodiment of the present invention, an alignment lock 60 is formed on the insert receiving surface 38. The alignment lock or notch 60 can be any suitable shape and size and is configured to matingly receive a corresponding alignment key or dowel 62 protruding from a core surface 64 of the top insert 16 facing the insert receiving surface 38 (best shown in FIG. 3). For example, the alignment key 62 can be a dowel and the lock 60, a hole configured to receive the dowel. The lock and key 60 and 62 facilitate alignment and prevent the misalignment of the top mold insert 16 in the insert receiving area during mounting of the top mold insert in the top mold base 12. In one embodiment, the location and/or the shape of the alignment lock and the key 60 and 62 are such that the top mold insert 16 can be mounted only if the mold insert is oriented in a predetermined direction relative to the top mold base 12. In other words, the top mold insert 16 cannot be mounted to the top mold base 12 if the insert is rotated, for example, 180° or the 90°, from a predetermined orientation relative to the top mold base. In an alternative embodiment, the alignment lock 60 is formed on the core surface 64 of the top mold insert 16, with the alignment key 62 protruding from the insert receiving surface 38 of the top mold base 12.

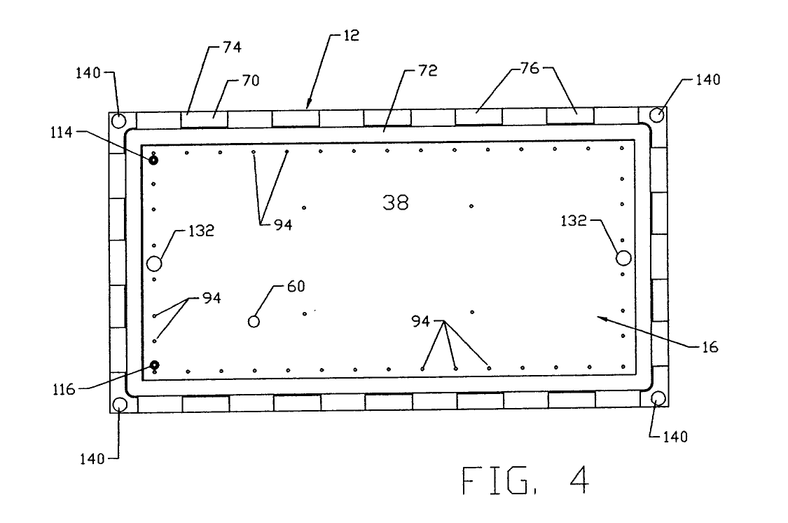

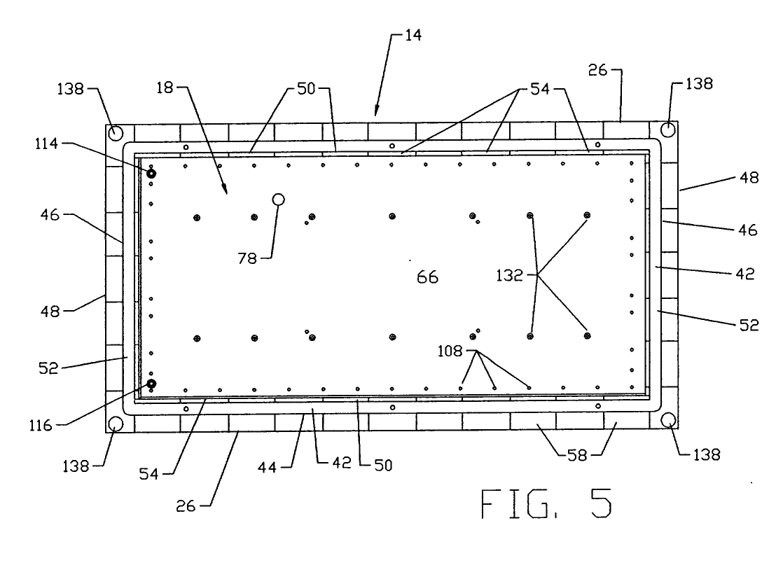

Turning now also to FIG. 4, the top mold base has an insert receiving area defined by an insert receiving surface 38 opposite an outside surface 40 (best shown in FIG. 3) which comes in contact with the top platen 28 of the press 30 when the top mold base 12 is mounted to the bottom platen. The insert receiving surface 38 is bounded by a ridge 70 which further defines the insert receiving surface 38 and extends in the general shape of the top mold base 12. The ridge 70 includes a shelf 72 which is stepped down from a generally flat top 74 of the ridge 70 toward the insert receiving surface 38.

The width of the shelf 72 is such that it is substantially the combined width of the bottom 52 and the shelf 50 of the ridge 42 on the bottom mold base 14, and the top 74 of the ridge 70 is substantially the width of the ledge 56 of the bottom mold base. With this arrangement, the bottom 52 of the bottom ridge 42 cooperatively engages the shelf 72 of the top ridge 70, and the ledge 56 of the bottom ridge cooperatively engages the top 74 of the bottom ridge (best shown in FIG. 3).

In one embodiment of the present invention, elongated mold stops 76 are attached to the top 74 of the ledge 70 at locations generally corresponding to the mold stops 58 on the bottom mold base 14 (best shown in FIG. 5). In this manner, the mold stops 58 on the bottom mold base 14 make contact with the mold stops 76 on the top mold base 14 to maintain a predetermined space between the top and bottom mold inserts 16 and 18, when the top and the bottom mold bases are pressed together. In one preferred embodiment, the mold stops 76 are formed from the same material as the mold stops 58. Also, a plurality of shorter stops 76 can be provided on each side or portion of the ledge 70.

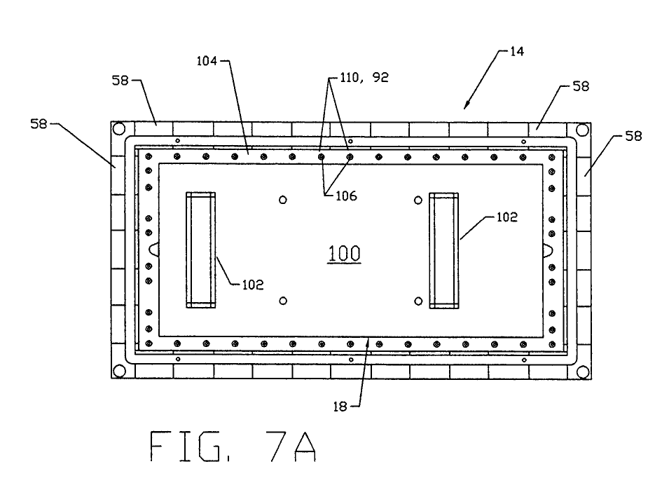

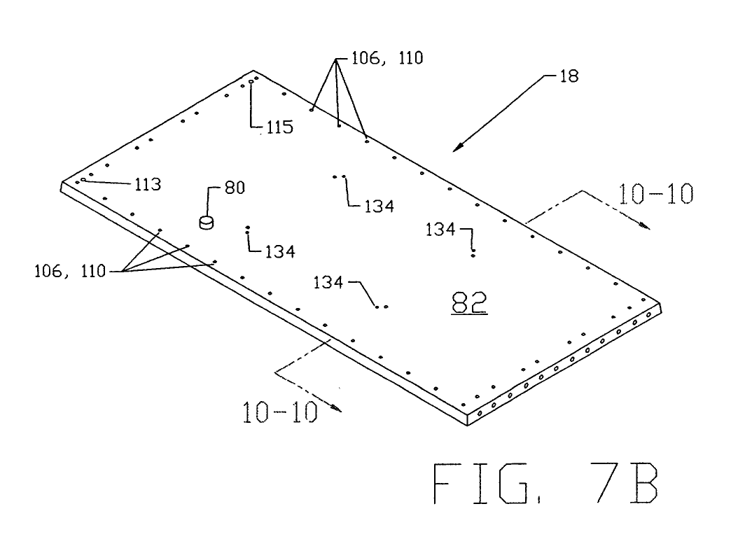

In one embodiment of the present invention, an alignment lock 78 is formed on the insert receiving surface 66. Similar to the alignment lock 60 of the top mold base 12, the alignment lock 78 can be any suitable shape and size and is configured to matingly receive a corresponding alignment key 80 such as a dowel protruding from a core surface 82 of the bottom mold insert 18 facing the insert receiving surface 66 of the bottom mold base 14 (best shown in FIGS. 3 and 7B). The lock and the key 78 and 80 facilitate alignment and prevent misalignment of the bottom mold insert 18 in the insert receiving area during the mounting of the bottom mold insert in the bottom mold base 12.

In one embodiment, the location and/or the shape of the alignment lock 78 and the key 80 are also such that the bottom mold insert 18 can be mounted only if it is oriented in a predetermined direction relative to the bottom mold base 14. The location and/or the shape of the alignment lock 78 and the key 80 are also such that the bottom mold insert 18 cannot be mounted to the top mold base 12, and likewise, the top mold insert 16 cannot be mounted to the bottom mold base 14. This arrangement eliminates the possibility of the mold inserts 16 and 18 being mounted to the wrong mold bases 14 and 12. In one alternate embodiment, the alignment lock 78 is formed on the core surface 82 of the bottom mold insert 18, with the alignment key 80 protruding from the insert receiving surface 66 of the bottom mold base 14.

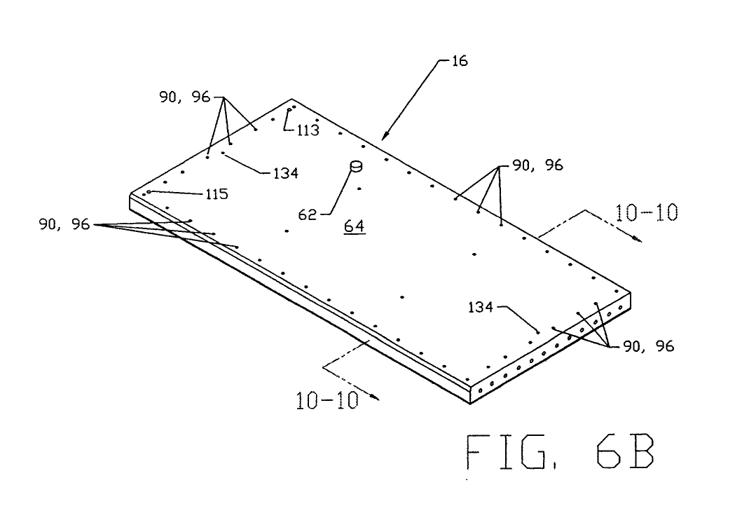

Referring now also to FIGS. 6A and 6B, the top insert 16 includes a cavity surface 84 opposite the core surface 64. At least one cavity 86 is formed in the cavity surface 84. The cavity 86 defines the shapes of the molded part 36, for example, the panels on a 6-panel door or decorative designs on a cabinet door, etc. The top insert 16 also includes a border 88 formed along the periphery of the top insert, and stepped up from the cavity surface 84. A plurality of through holes or apertures 90 which extend from the border 88 to the core surface 64 are provided generally spaced along the border. A corresponding number of fasteners such as retention bolts 92 are inserted into the through holes 90 (best shown in FIG. 6A) and threaded into a corresponding thread holes 94 formed in the top mold base 12 (best shown in FIG. 4) to mount the top insert 16 to the top mold base 12. As best shown in FIG. 6B, the through holes 90 are countersunk on the border 88 to a depth which would not allow retention bolts 92 to interfere with the top and the bottom inserts 16 and ′18 from being pressed to a desired distance from each other, as determined by the mold stops 58 and 76 described above.

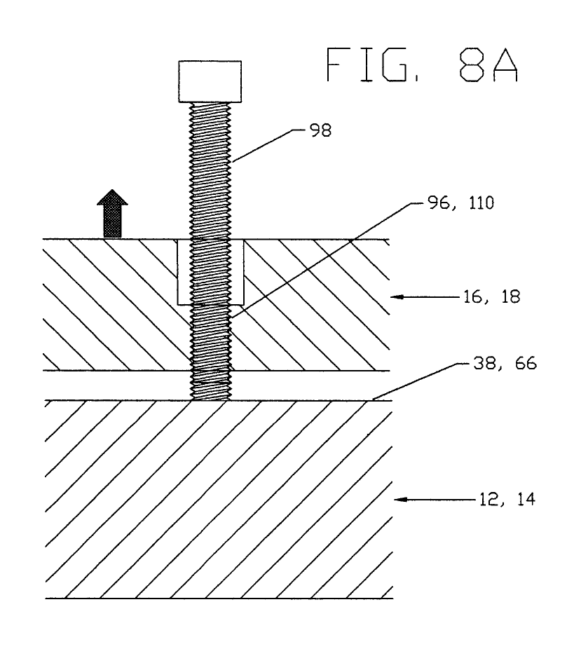

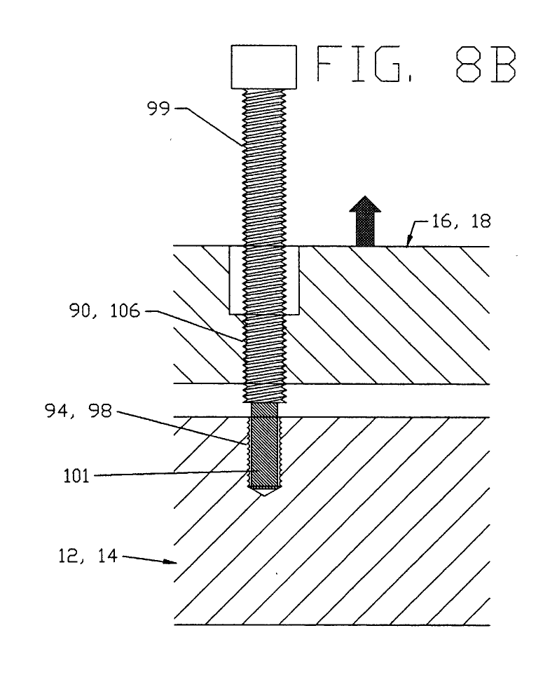

In one embodiment of the present invention, a plurality of threaded through holes 96 which extend from the border 88 to the core surface 64 are also formed along the border of the top mold insert 16. The threaded through holes 96 are provided to facilitate detachment of the top mold insert 16 from the top mold base 12. Referring now also to FIG. 8A, the threaded through holes 96 are configured to cooperatively receive a mounting members such as screws or bolts 98, preferably a jackscrew, which are longer than the distance from the border 88 to the core surface 64. To detach the top mold insert 16 from the top mold base 12, the bolts 98 are threaded into the holes 96 until they come in contact with the insert receiving surface 38. The bolts 98 are then continued to be threaded until the top mold insert 16 becomes detached or moved out of the insert receiving surface 38, and grasped by a lifting device such as a forklift for removal and movement to a storage location.

In an alternate embodiment, the top mold insert 16 is detached from the top mold base 12 using the existing through holes 90 in the top mold insert and the threaded holes 94 in the top mold base. This arrangement eliminates the need for dedicated holes 96 for separating the top mold insert 16 from the top mold base 12. In this embodiment, as shown in FIG. 8B, the through holes 90 in the top mold insert also have threads, which correspond in dimensions to the threads in the holes 94 in the top mold base 12. This allows the retention bolts 92 to be threaded past the top mold insert 16 to engage the holes in the top mold base 12 to mount the top mold insert to the top mold base.

To detach the top mold insert 16, the retention bolts 92 are first removed from the top mold base 12 and the top mold insert 16. Then a suitable member such as a bolt 99 is threaded into each hole 90 in the top mold insert 16. Each of the bolts 99 includes a foot portion 101 which has smaller diameter than that of the through holes 90 in the top mold insert 16. Accordingly, the foot portion 101 contacts the bottom of the hole 94 in the top mold base 12 when the bolt 99 is threaded through hole 90 in the top mold insert 16. As the bolts 99 are continued to be threaded, force is exerted on the top mold base 12 by the foot portion 101 of the bolts 99, thereby separating the top mold insert 16 from the top mold base.

Referring now to FIGS. 7A and 7B, the bottom mold insert 18 in one embodiment, similar to the top mold insert 16, includes a cavity surface 100 (best shown in FIG. 7A) opposite the core surface 82 (best shown in FIG. 7B) facing the mold insert receiving surface 66 of the bottom mold base. At least one cavity 102 is formed in the cavity surface 100. The cavity 102 also defines the shapes of the molded part 36, for example, the panels on a 6-panel door or decorative designs on a cabinet door, etc. The bottom insert 18 also includes a border 104 formed along its periphery. The border 104 is stepped down from the cavity surface 100, so as to be complement to the stepped up border 88 of the top mold insert 16 (best shown in FIG. 3).

A plurality of through holes 106 which extend from the border 104 to the core surface 82 are provided generally spaced along the border. A corresponding number of the retention bolts 92 are inserted in the through holes 106 and threaded into a corresponding thread holes 108 formed in the bottom mold base 14 (best shown in FIG. 5) to mount the bottom insert 18 to the bottom mold base. The through holes 106, as in the through holes 90 of the top mold insert 16, are also are countersunk on the border 104 to a depth which would not allow retention bolts 92 to interfere with the top and the bottom inserts 16 and 18 from being pressed to a desired distance from each other, as determined by the mold stops 58 and 76 described above.

In one embodiment of the present invention, a plurality of threaded through holes 110 which extend from the border 104 to the core surface 82 are also formed along the border of the bottom mold insert 18. The threaded through holes 110, as in the threaded through holes 96 of the top mold insert 16, are provided to facilitate detachment of the bottom mold insert 18 from the bottom mold base 14, in the manner described above with reference to FIG. 8A.

In an alternate embodiment, the bottom mold insert 18 is detached from the bottom mold base 14 using the existing the through holes 106 on the bottom mold insert and the threaded holes 108 in the bottom mold base, thereby eliminating the need for dedicated threaded holes 106 as in the embodiment described above. In operation, the bolts 99 are used to separate the bottom mold insert 18 from the bottom mold base 14 in a manner similar to the way the top mold insert 16 is separated from the top mold base 12 as described above with reference to FIG. 8B. Accordingly, the through holes 106 also have threads, which correspond in dimensions to the threads in the holes 108 in the bottom mold base 14. This allows the retention bolts 92 to extend past the bottom mold insert 18 to engage the holes 108 in the bottom mold base 14 when the bottom mold insert is being mounted to the bottom mold base.

It should be appreciated that the inserts and mold bases of the present invention may employ tapered or angled surfaces to facilitate the mounting of the inserts in the bases. For example, one tapered surface of the bottom insert is illustrated in FIG. 3. It should also be appreciated that individual parts of the mold inserts and mold bases such as the keys and locks could have tapered surfaces to facilitate the alignment of such members. The tapered surfaces facilitate the self-adjustment of the inserts and mold bases during the installation process.

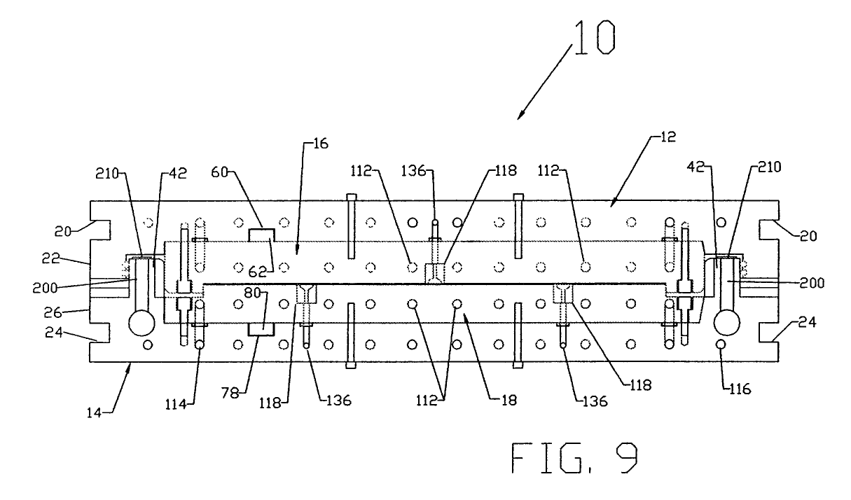

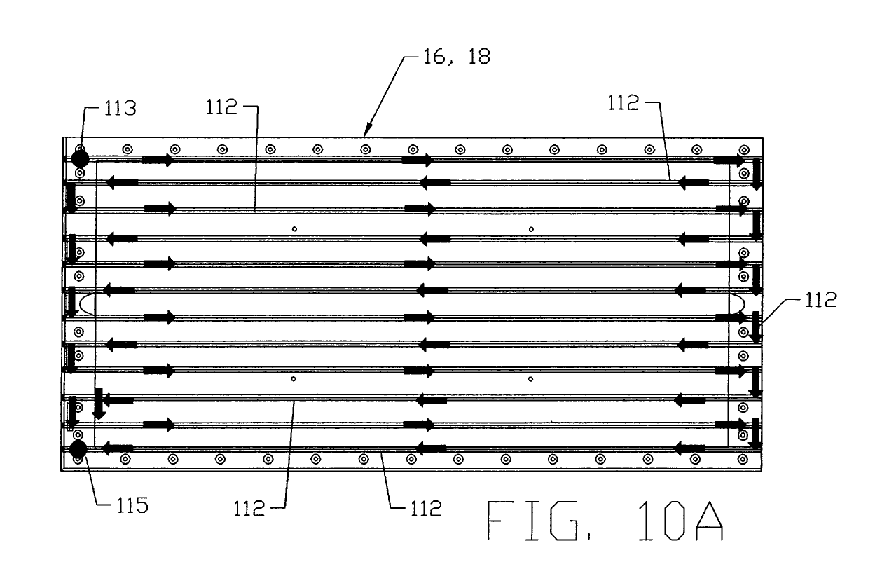

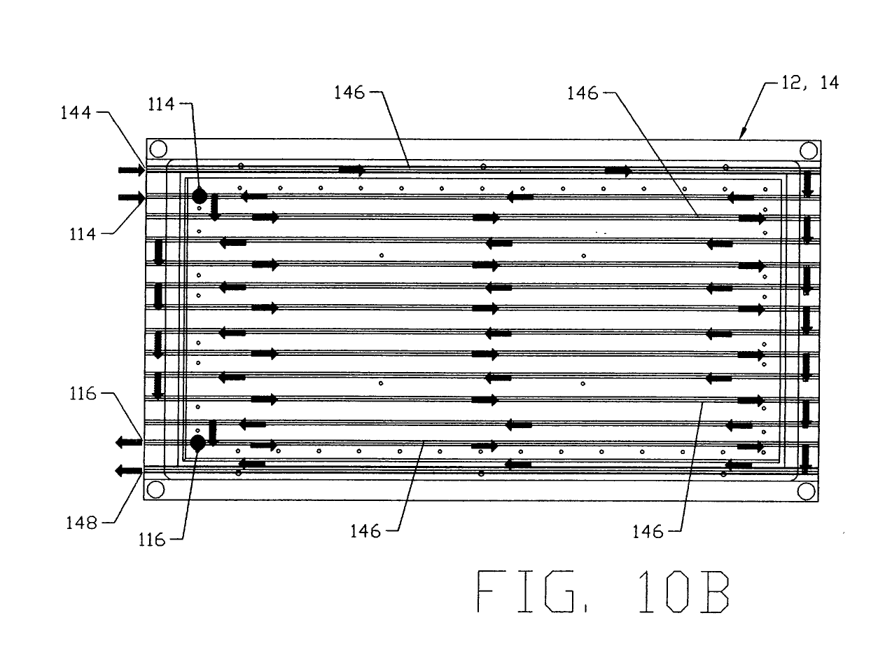

Turning now to FIGS. 9 and 10 (sectional view of FIG. 6B or 7B shown with parts omitted for clarity), and in one embodiment of the present invention, at least one steam channel 112 (two shown in FIGS. 9 and 10) is embedded in each of the top and the bottom inserts 16 and 18 for allowing steam or other heated fluids to be circulated through the channel. Each steam channel 112 has an inlet or inlet port 113 (best shown in FIGS. 6B and 7B) which is connected to and in fluid communication with a corresponding steam inlet 114, and an outlet port 115 which is connected to and in fluid communication with a steam outlet 116 provided on the top and the bottom mold bases 12 and 14. The steam inlet and the outlet 114 and 116 extend from the top and the bottom mold insert receiving surfaces 38 and 66 (best shown in FIGS. 4 and 5) to the side of their respective mold bases 12 and 14 (best shown in FIGS. 1 and 9) where they are connected to a steam trap (not shown). Steam is circulated through the steam channel 112 to heat the mold inserts 16 and 18, thereby enabling the heat to be transferred to the mold material inserted between the mold inserts during the molding process to facilitate formation of the molded part 36.

In one embodiment, steam is also circulated through the mold bases as illustrated in FIG. 10B. In this embodiment the mold base includes an inlet or inlet port 144, a plurality of steam lines or communication channels 146 and an outlet or outlet port 148.

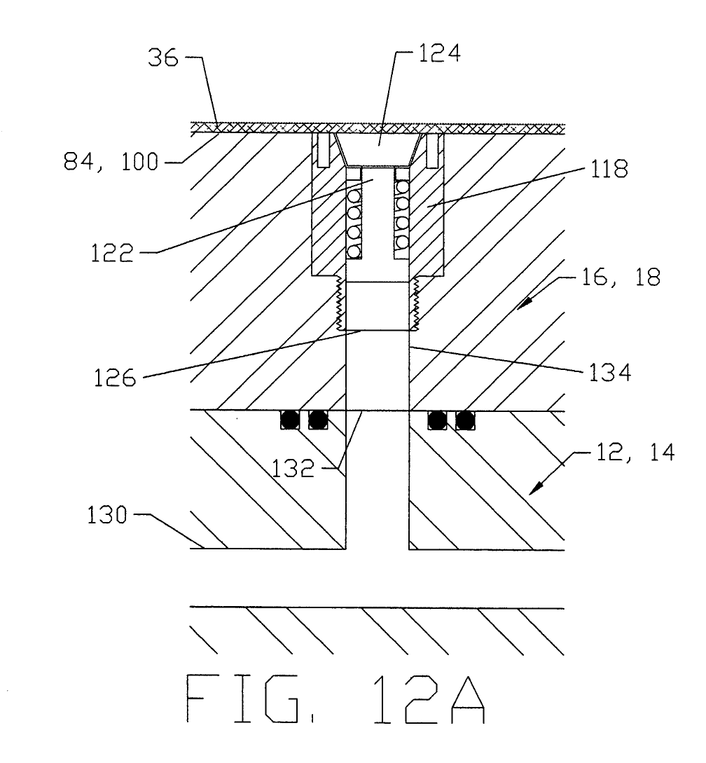

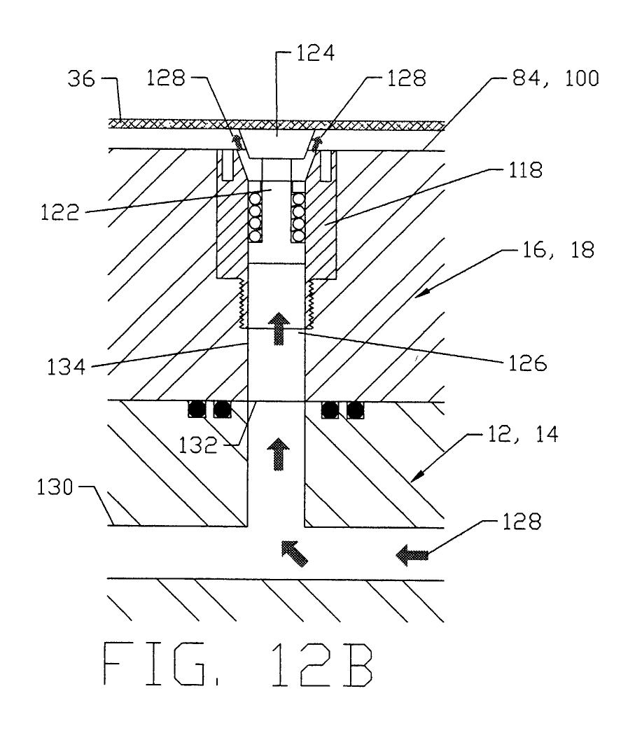

Referring also now to FIGS. 9, 11, 12A and 12B, and in accordance with one embodiment of the present invention, the top and bottom mold inserts 16 and 18 each include one or more and preferably a plurality of air poppets 118 for separating the molded part 36 from the mold inserts after the formation of the molded part. Although many types of air poppets are workable, SUMMO air poppets, where the poppets are screwed into the mold inserts 16 and 18, are presently preferred (best shown in FIGS. 12A and 12B).

The air poppets 118 include a generally cylindrical housing 120 which is threaded at least a portion of its length (best shown in FIGS. 12A and 12B). A valve 122 is provided in the housing 120 and has a head 124 which is seated substantially flush with the cavity surface 84 or 100 on which the poppet 118 is mounted, when in a first resting or non-pressurized position (best shown in FIGS. 9 and 12A). The air poppets 118 have an air inlet 126 at the end opposite the head 124 for allowing pressurized air 128 to be injected into the housing 120 (best shown in FIG. 12B). In operation, the air 128 forces the valve 122 to be projected out of the housing 120 to lift the molded part 36 off the cavity surfaces 84 and 100 (best shown in FIG. 12B).

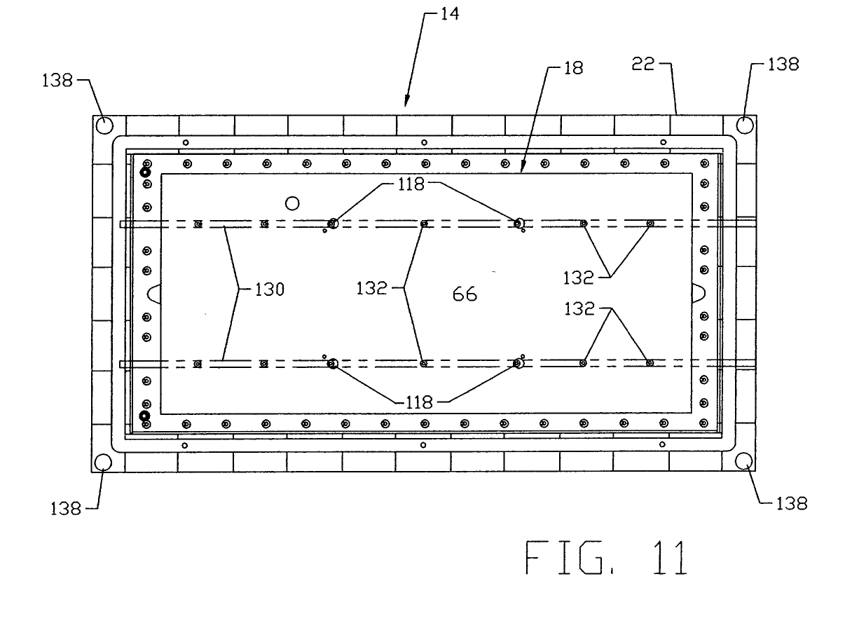

In one embodiment of the present invention, pressurized air is supplied to the air poppets 118 via at least one air supply line 130 which is embedded and extends through the top and the bottom mold bases 12 and 14 (two air supply lines are shown in phantom lines in FIG. 11, which shows the bottom mold insert 18 mounted to the bottom mold base 12, as an example, with parts omitted for clarity). A plurality of air holes 132 are provided along the length of the air supply lines 130 and extend up to the mold insert receiving surface 38 or 66 of their corresponding mold insert 12 or 14 (see also FIGS. 4 and 5).

In one embodiment of the present invention, the air inlet 126 on the poppets 118 are connected to the air holes 132 via a plurality of air outlets or connectors 134 respectively formed in the top and the bottom mold inserts 16 and 18 (best shown in FIGS. 6B and 7B). Each air connector 134 is positioned so that it connects to one of the proximate air holes 132 when the top and the bottom mold inserts 16 and 18 are mounted to their respective top and bottom mold bases 12 and 14. The air supply lines 130 have an air inlet 136 provided at the end of the mold bases 12 and 14 (best shown in FIGS. 1 and 2). An air compressor (not shown) is suitable connected to the air inlets 136 for supplying pressurized air to the air poppets 118.

Advantageously, the air holes 132 provided along the air supply lines 103 enable the air poppets 118 to be positioned substantially at any desired location on the cavity surfaces 84 and 100 of the top and the bottom mold inserts 16 and 18, as dictated by the dimensions and the design of the part 36 being formed. The air supply line 130 and the air holes 132 of the present invention also simplifies formation of the air connectors 134 (i.e., allows the air connectors to be short and relatively straight), since the air poppets 118 will be located in close proximity to the any one of the air holes, if not directly over the air holes.

The bottom mold base 14 is provided with plurality of guide holes 138 each of which are configured to cooperatively receive a corresponding guide or guide pin 140 mounted to the top mold base. The guides 140 serve to facilitate the precise alignment of the top and bottom mold bases.

The compression molding apparatus of one embodiment of the present invention includes internal vacuum ports 200 in the mold bases best seen in FIG. 9. Since the vacuum assemblies are preferably in the mold bases, they do not need to be changed with the changing of the mold inserts. The vacuum ports are operated to remove air trapped in the cavity between the top and bottom mold inserts and the mold material therein during the compression molding process. The inlets or inlet ports are preferably covered by protective screens such as mesh screens to prevent any excess molding material from being pulled into the inlet ports. One embodiment of the present invention thus provides for evacuation of air and mold gasses from the mold chamber during the compression molding of a part. One embodiment of the present invention includes vacuum communication circuit including a vacuum port or a series of ports connections to an external vacuum source, the protective screens filtering the ports circumferential seal groove(s), and a flexible seal (such as two redundant seals.

In one alternative embodiment of the present invention, the compression molding apparatus and particularly the mold bases include suitable hydraulically operated ejectors or ejector pin assemblies which are embedded into the mold base and employed for removing and installing the mold inserts in the mold bases. Such ejectors would be mounted in or built-in the mold bases to facilitate the automatic installation and removal of the mold inserts from the mold bases.

The present invention thus provides a compression molding apparatus which includes interchangable mold inserts which are used to form different parts. The mold inserts are readily changeable and substantially reduce the tooling costs necessary for molds because the mold inserts use common top and bottom mold bases. The mold bases do not need to be removed from the hydraulic presses.

While the present invention is described in connection with what is presently considered to be the most practical and preferred embodiments it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A compression molding apparatus for producing a molded part, said apparatus comprising:
a first mold base having a receiving surface;
a first mold insert removably attached to said first mold base, said first mold insert having an attachment surface opposite said receiving surface of said first mold base;
one of a first key and a first lock formed on said receiving surface and the other of said first key and said first lock formed on said attachment surface of said first mold insert, said first key and said first lock being operable to enable said first mold insert to be attached said first mold base;
a second mold base positioned opposite said first mold base and having a receiving surface; and
a second mold insert removably attached to said second mold base, said second mold insert having an attachment surface opposite said receiving surface of said second mold base,
wherein said mold inserts are operable to compression mold a material to form the molded part when said first mold base and said second mold base are pressed together.

2. The compression molding apparatus of claim 1, which includes one of a second key and a second lock formed on said receiving surface of said second mold base, and the other of said second key and said second lock formed on said attachment surface of said second mold insert, said second key and said second lock being operable to enable said second insert to be attached to said second mold base.

3. The compression molding apparatus of claim 2, wherein said first key is formed on said attachment surface of said first mold insert and said second key is formed on said attachment surface of said second mold insert.

4. The compression molding apparatus of claim 1, wherein said first key is formed on said attachment surface of said first mold insert.

5. The compression molding apparatus of claim 1, wherein said first mold base and said second mold base are each removably mounted to a press for pressing said first mold base and said second mold base together.

6. The compression molding apparatus of claim 1, which includes at least one stop pad on at least one of said first mold base and said second mold base such that said first mold base and said second mold base abut said stop pad when said first and said second mold bases are pressed together to compress the material.

7. The compression molding apparatus of claim 6, which includes a plurality of stop pads positioned along a periphery of said one of said first mold base and said second mold base.

8. The compression molding apparatus of claim 7, wherein said plurality of stop pads are on said first mold base and said second mold base.

9. A compression molding apparatus for producing a molded part, said apparatus comprising:
a first mold base having a receiving surface;
a first mold insert removably attached to said first mold base, said first mold insert having an attachment surface opposite said receiving surface of said first mold base;
a second mold base positioned opposite said first mold base and having a receiving surface;
a second mold insert removably attached to said second mold base, said second mold insert having an attachment surface opposite said receiving surface of said second mold base, wherein said mold inserts are operable to compression mold a material to form the molded part when said first mold base and said second mold base are pressed together; and
a plurality of heel blocks attached to said first mold base for operably engaging said second mold insert to align said second mold insert within said first mold base when said first and said second mold inserts are pressed together.

10. The compression molding apparatus of claim 9, which includes one of a first key and a first lock formed on said receiving surface and the other of said first key and said first lock formed on said attachment surface of said first mold insert, said first key and said first lock being operable to enable said first mold insert to be attached said first mold base.

11. A compression molding apparatus for producing a molded part, said apparatus comprising:
a first mold base having a receiving surface;
a first mold insert removably attached to said first mold base, said first mold insert having an attachment surface opposite said receiving surface of said first mold base and defining a first heat conducting channel extending through said first mold insert;
a second mold base positioned opposite said first mold base and having a receiving surface; and
a second mold insert removably attached to said second mold base, said second mold insert having an attachment surface opposite said receiving surface of said second mold base and defining a second heat conducting channel extending through said second mold insert,
wherein said mold inserts are operable to compression mold a material under heat to form the molded part when said first mold base and said second mold base are pressed together.

12. The compression molding apparatus of claim 11, wherein said first and said second heat conducting channels extend laterally respectively through said first and said second mold inserts.

13. The compression molding apparatus of claim 11, wherein said first mold base includes a first heat inlet which extends from said receiving surface of said first mold base to an outer surface of said first mold base and in fluid communication with said heat conducting channel of said first mold insert, and a first heat outlet which extends from said receiving surface of said first mold base to an outer surface of said first mold base and in fluid communication with said first heat conducting channel; and
said second mold base includes a second heat inlet which extends from said receiving surface of the second mold base to an outer surface of said second mold base and in fluid communication with said second heat conducting channel of said second mold insert, and a heat outlet which extends from said receiving surface of said second mold base to an outer surface of said second mold base and in fluid communication with said heat conducting channel of said second insert.

14. The compression molding apparatus of claim 13, which includes at least one steam source connected to said first and said second heat inlets at said outer surfaces of said first and said second mold bases.

15. A compression molding apparatus for producing a molded part, said apparatus comprising:
a first mold base having a receiving surface and defining at least one air line extending through said first mold base and a plurality of air holes extending from said air line to said receiving surface of said first mold base;
a first mold insert removably attached to said first mold base, said first mold insert having an attachment surface opposite said receiving surface of said first mold base;
a second mold base positioned opposite said first mold base and having a receiving surface and defining at least one air line extending through said second mold base, and a plurality of air holes extending from said air lines to said receiving surface of said second mold base;
a second mold insert removably attached to said second mold base, said second mold insert having an attachment surface opposite said receiving surface of said second mold base;
at least one air operated valve embedded in said first mold insert and in fluid communication with a corresponding one of said air holes in said first mold base, said valve being operable to extend out of said cavity surface of said first mold insert to separate the molded part from said first mold insert;
at least one second air operated valve embedded in said second mold insert and in fluid communication with a corresponding one of said air holes in said second mold base, said second valves being operable to protrude from said cavity surface of said second mold insert to separate the molded part from said second mold insert; and
wherein said mold inserts are operable to compression mold a material to form the molded part when said first mold base and said second mold base are pressed together.

16. The compression molding apparatus of claim 15, which includes at least one air inlet extending from an outer surface of said first mold base and in fluid communication with at least one said air line in said first mold base, and at least one air inlet extending from an outer surface of said second mold base and in fluid communication with said at least one air line in said second mold base.

17. The compression molding apparatus of claim 16, which includes an air source connected to said air inlets at said outer surfaces of said first and said second mold bases.

18. A compression molding apparatus for producing a molded part, said apparatus comprising:
a first mold base having a receiving surface;
a first mold insert removably attached to said first mold base, said first mold insert having an attachment surface opposite said receiving surface of said first mold base;
said first mold insert defining a plurality of attachment through holes extending from said attachment surface to a cavity surface of said first mold insert;
said first mold base defining a plurality of threaded holes corresponding to said attachment through holes of said first mold insert for having said first mold insert removably attached to said first mold base when a plurality of fastening members are threaded through said attachment through holes of said first mold insert and into said threaded holes of said first mold base;
a second mold base positioned opposite said first mold base and having a receiving surface;
a second mold insert removably attached to said second mold base, said second mold insert having an attachment surface opposite said receiving surface of said second mold base, wherein said mold inserts are operable to compression mold a material to form the molded part when said first mold base and said second mold base are pressed together;
said second mold insert defining a plurality of attachment through holes extending from said attachment surface to a cavity surface of said second mold insert; and
said second mold base defining a plurality of threaded holes corresponding to said attachment through holes of said second mold insert for having said second mold insert removably attached to said first mold base when a plurality of fastening members are threaded through said attachment through holes of said second mold insert and into said threaded holes of said second mold base.

19. The compression molding apparatus of claim 18, wherein said attachment through holes in said first mold insert and said second mold insert are countersunk at said cavity surfaces of said first and said second mold inserts.

20. The compression molding apparatus of claim 18, wherein said through holes are formed along a periphery of said first mold insert and said second mold insert.

21. The compression molding apparatus of claim 18, wherein said first mold insert and said second mold insert includes a plurality of threaded mounting through holes extending from said cavity surface to said attachment surface, said threaded through holes used to detach said first mold insert from said first mold base and said second mold insert from said second mold base by threading a bolt through said threaded holes and against said corresponding receiving surface of said first mold base and said second mold base.

22. The compression molding apparatus of claim 21, wherein said mounting threaded through holes are formed along a periphery of said first mold insert and said second mold insert.

23. The compression molding apparatus of claim 18, wherein each of said through holes on said first mold insert is threaded to operably receive a threaded bolt for cooperatively detaching said first mold insert from said first mold base, and each of said through holes on said second mold insert is threaded to operably receive a threaded bolt for cooperatively detaching said second mold insert from said second mold base.

24. The compression molding apparatus of claim 18, which includes vacuum means in at least one of the first and second mold bases for removing air between the inserts when said first and second mold bases are pressed together.

25. A compression molding apparatus for producing a molded part, said apparatus comprising:
a first mold base having a receiving surface and defining at least one air line extending through said first mold base and a plurality of air holes extending from said air line to said receiving surface of said first mold base;
a first mold insert removably attached to said first mold base, said first mold insert having an attachment surface opposite said receiving surface of said first mold base and defining a first heat conducting channel extending through said first mold insert;
one of a first key and a first lock formed on said receiving surface and the other of said first key and said first lock formed on said attachment surface of said first mold insert, said first key and said first lock being operable to enable said first mold insert to be attached said first mold base;
a second mold base positioned opposite said first mold base and having a receiving surface and defining at least one air line extending through said second mold base, and a plurality of air holes extending from said air lines to said receiving surface of said second mold base;
a second mold insert removably attached to said second mold base, said second mold insert having an attachment surface opposite said receiving surface of said second mold base and defining a second heat conducting channel extending through said second mold insert;
one of a second key and a second lock formed on said receiving surface of said second mold base, and the other of said second key and said second lock formed on said attachment surface of said second mold insert, said second key and said second lock being operable to enable said second insert to be attached to said second mold base,
wherein said first mold base and said second mold base are mounted to a press for pressing said first mold base and said second mold base together and wherein said mold inserts are operable to compression mold under heat a material to form the molded part when said first mold base and said second mold base are pressed together.

26. The compression molding apparatus of claim 25, which includes at least one stop pad on at least one of said first mold base and said second mold base so that said first mold base and said second mold base abut said stop pad when said first and said second mold bases are pressed together to compress the material.

27. The compression molding apparatus of claim 25, which includes a plurality of heel blocks attached to said first mold base for operably engaging said second mold insert to align said second mold insert within said first mold base when said first and said second mold inserts are pressed together.

28. The compression molding apparatus of claim 25, wherein said first mold base includes a first heat inlet which extends from said receiving surface of said first mold base to an outer surface of said first mold base and in fluid communication with said heat conducting channel of said first mold insert, and a first heat outlet which extends from said receiving surface of said first mold base to an outer surface of said first mold base and in fluid communication with said first heat conducting channel; and
said second mold base includes a second heat inlet which extends from said receiving surface of the second mold base to an outer surface of said second mold base and in fluid communication with said second heat conducting channel of said second mold insert, and a heat outlet which extends from said receiving surface of said second mold base to an outer surface of said second mold base and in fluid communication with said heat conducting channel of said second insert.

29. The compression molding apparatus of claim 25, which includes at least one steam source connected to said first and said second heat inlets at said outer surfaces of said first and said second mold bases.

30. The compression molding apparatus of claim 25, which includes at least one air operated valve embedded in said first mold insert and in fluid communication with a corresponding one of said air holes in said first mold base, said valve being operable to extend out of said cavity surface of said first mold insert to separate the molded part from said first mold insert, and at least one second air operated valve embedded in said second mold insert and in fluid communication with a corresponding one of said air holes in said second mold base, said second valves being operable to protrude from said cavity surface of said second mold insert to separate the molded part from said second mold insert.

31. The compression molding apparatus of claim 30, which includes at least one air inlet extending from an outer surface of said first mold base and in fluid communication with at least one said air line in said first mold base, and at least one air inlet extending from an outer surface of said second mold base and in fluid communication with said at least one air line in said second mold base.

32. The compression molding apparatus of claim 31, which includes an air source connected to said air inlets at said outer surfaces of said first and said second mold bases.

33. The compression molding apparatus of claim 25, wherein said first mold insert defines a plurality of attachment through holes extending from said attachment surface to a cavity surface of said first mold insert;
said first mold base defines a plurality of threaded holes corresponding to said attachment through holes of said first mold insert for having said first mold insert removably attached to said first mold base when a plurality of fastening members are threaded through said attachment through holes of said first mold insert and into said threaded holes of said first mold base;
said second mold insert defines a plurality of attachment through holes extending from said attachment surface to a cavity surface of said second mold insert; and
said second mold base defines a plurality of threaded holes corresponding to said attachment through holes of said second mold insert for having said second mold insert removably attached to said first mold base when a plurality of fastening members are threaded through said attachment through holes of said second mold insert and into said threaded holes of said second mold base.

34. The compression molding apparatus of claim 33, wherein said attachment through holes in said first mold insert and said second mold insert are countersunk at said cavity surfaces of said first and said second mold inserts.

35. A compression molding apparatus for forming molded parts using a plurality of removable mold inserts, the apparatus comprising:
a first mold base mountable to a press and having a receiving surface for having a mold insert removably attached thereto;
one of a first key and a first lock formed on said receiving surface for matingly engaging the other of said first key and said first lock formed on the mold insert to enable the mold insert to be attached to said first mold base; and
a second mold base mountable to said press and having a receiving surface opposite said receiving surface of said first mold base for having a mold insert removably attached thereto,
wherein said press is operable to press said first mold base and said second mold base together to compress a material between the mold inserts attached to said first mold base and second mold base for forming the molded part.

36. The compression molding apparatus of claim 35, which includes one of a second key and a second lock formed on said receiving surface of said second mold base, the other of said second key and said second lock being formed on the mold insert, said second key and said second lock being operable to enable the mold insert to be removably attached to said receiving surface of said second mold base.

37. The compression molding apparatus of claim 36, wherein said first lock is formed on said receiving surface of said first mold base, said second lock is formed on said receiving surface of said second mold base.

38. The compression molding apparatus of claim 35, wherein said first lock is formed on said receiving surface of said first mold base.

39. The compression molding apparatus of claim 35, which includes a plurality of stop pads positioned along a periphery of said one of said first mold base and said second mold base, said first mold base and said second mold base being operable to abut said stop pads when said first and said second mold bases are pressed together to compress the part to be molded.

40. The compression molding apparatus of claim 39, wherein said plurality of stop pads are on said first mold base and said second mold base.

41. The compression molding apparatus of claim 35, which includes a plurality of heel blocks attached to said first mold base for engaging the mold insert attached to said second mold base to align the mold insert within said first mold base when said first and said second mold bases are pressed together.

42. The compression molding apparatus of claim 35, wherein said first mold base includes a first heat inlet and a first heat outlet extending from said receiving surface of said first mold base to a side of said first mold base and being operably connected to a heat conducting channel extending through the mold insert mounted to said first mold base, and said second mold base includes a second heat inlet and a second heat outlet extending from said mold insert receiving surface of said second mold base to a side of said second mold base and being operably connected to a heat conducting channel extending through the mold insert mounted to said second mold base.

43. The compression molding apparatus of claim 35, which includes a plurality of air lines extending laterally through said first mold base and said second mold base, a plurality of air holes extending from said air lines to said receiving surfaces of said first mold base and said second mold base, and at least one air inlet extending from an outer surface of said first mold base and in fluid communication with said air lines in said first mold base for supplying air through said air lines in said first mold base, and at least one air inlet extending from an outer surface of said second mold base and in fluid communication with said air lines in said second mold base for supplying air through said air lines in said second mold base, said air holes being operable to be connected to a plurality of air operated valves embedded in the mold inserts for separating the molded part from the mold inserts.

44. The compression molding apparatus of claim 35, wherein said receiving surface of said first mold base has a plurality of threaded holes which correspond with through holes formed on the mold insert to be attached to said first mold base for mounting the mold insert to said first mold base, and said receiving surface of said second mold base has a plurality of threaded holes which correspond with through holes formed on the mold insert to be attached to said second mold base for mounting the mold insert to said second mold base.

45. The compression molding apparatus of claim 44, wherein said threaded holes on said first mold base are operable to detach said first insert from said first mold base when a bolt is threaded through the though holes formed on the first insert attached to the first mold base and pressed against bottoms of the threaded holes on said first mold base, and said threaded holes on said second mold base are operable to detach said second insert from said second mold base when a bolt is threaded through the though holes formed on the second insert attached to the second mold base and pressed against bottoms of the threaded holes on said second mold base.

46. A compression molding apparatus for forming molded parts using a plurality of removable mold inserts having heat conduction channels for supplying heat to molding material to be molded between the mold inserts into the molded parts, said apparatus comprising:
a first mold base mountable to a press and having a receiving surface for having a mold insert removably attached thereto, said first mold base including a first heat inlet which extends from an outer surface of said first mold base to said receiving surface of said first mold base and operable to be in communication with the heat conduction channel of the corresponding mold insert for supplying heat into the heat conducting channel, and a first heat outlet which extends from an outer surface of said first mold base to said receiving surface of said first mold base and operable to be in communication with the heat conduction channel of the corresponding mold insert for releasing heat from the heat conducting channel; and
a second mold base mountable to said press and having a receiving surface for having a mold insert removably attached thereto, said second mold base including a second heat inlet which extends from an outer surface of said second mold base to said receiving surface of said second mold base and operable to be in communication with the heat conduction channel of the corresponding mold insert for supplying heat to the heat conducting channel, and a second heat outlet which extends from an outer surface of said second mold base to said receiving surface and operable to be in communication with the heat conduction channel of the mold insert for releasing heat from the corresponding heat conducting channel;
wherein said press is operable to press said first mold base and said second mold base together to compress the material to be molded between the mold inserts attached to said first mold base and second mold base to form the molded parts.

47. The compression molding apparatus of claim 46, which includes a steam supply device operably connected to said first and second heat inlets on said outer surfaces of said first and second mold bases for supplying steam to the heat conducting channels in the mold inserts operable to be attached to said first and said second mold bases.

48. A compression molding apparatus for forming molded parts using a plurality of removable mold inserts having air operated valves for separating parts molded between the mold inserts, said apparatus comprising:
a first mold base having a receiving surface adapted to receive a mold insert said first mold base defining at least one air line extending through the first mold base, and a plurality of air holes extending from said air lines to said receiving surface of said first mold base; and
a second mold base having a receiving surface opposite said receiving surface of said first mold base adapted to receive a mold insert removably attached thereto said first mold base defining at least one air line extending through the second mold base and having a plurality of air holes extending from said air lines to said receiving surface of said second mold base; and
wherein said air holes in said first mold base and said second mold base are operable to be connected to the air operated valves embedded in the corresponding mold inserts to be attached to said first and said second mold bases for separating the molded parts from the mold inserts.

49. The compression molding apparatus of claim 48, which includes at least one air inlet extending from an outer surface of said first mold base and in fluid communication with said air lines in said first mold base for supplying air through said air lines in said first mold base, and at least one air inlet extending from an outer surface of said second mold base and in fluid communication with said air lines in said second mold base for supplying air through said air lines in said second mold base.

50. The compression molding apparatus of claim 49, which includes an air supply removably connected to said air inlets of said first and said second mold bases for supplying air to said air lines in said first and said second mold bases.

51. A compression molding apparatus for forming molded products using a plurality of removable mold inserts having mold cavities, said apparatus comprising:
a first mold base having a receiving surface for having a mold insert removably attached thereto, said receiving surface having a plurality of threaded holes for cooperatively receiving a threaded attachment device for removably attaching the mold insert to the receiving surface;
a second mold base having a receiving surface opposite said receiving surface of said first mold base for having a mold insert removably attached thereto, said receiving surface of said second mold base having a plurality of threaded holes for cooperatively receiving a threaded attachment device for attaching the mold insert to the receiving surface of said second mold base.

52. The compression molding apparatus of claim 51, wherein said threaded holes are provided along a periphery of said first and second mold bases.

53. The compression molding apparatus of claim 51, wherein said threaded holes on said first mold base are used to detach the mold insert from said first mold base when a bolt is threaded through the though holes formed on the mold insert attached to the first mold base and pressed against bottoms of the threaded holes on said first mold base, and said threaded holes on said second mold base are used to detach the mold insert from said second mold base when a bolt is threaded through the though holes formed on the mold insert attached to the second mold base and pressed against bottoms of the threaded holes on said second mold base.

54. A compression molding apparatus for forming molded products using a plurality of removable mold inserts having mold cavities, said apparatus comprising:
a first mold base having a receiving surface for having a mold insert removably attached thereto;
a ridge extending along a periphery of said receiving surface;
a plurality of heel blocks attached to an inside of said ridge; and
a second mold base having a receiving surface opposite said receiving surface of said first mold base for having a mold insert removably attached thereto,
wherein said heel blocks are operable to receive the mold insert attached to said second mold base and align the mold insert of said second mold base within said ridge of said first mold base when said first and said second mold bases are pressed together.

55. A mold insert configured and operable to be removably attached to a mold base which is mounted to a press in a compression molding apparatus for forming a molded part, said mold insert comprising:
a first surface having a cavity for forming a molded part in a desired shape;
a second surface operable to be removably attached to a surface of the mold base for receiving said mold insert; and
one of a key and a lock formed on said second surface for matingly engaging the other of said key and said lock formed on the receiving surface of the mold base for aligning said mold insert on the receiving surface of the mold base.

56. The mold insert of claim 55, wherein said key is formed on said second surface of said mold insert and said lock is formed on the receiving surface of the mold base.

57. The mold insert of claim 55, which defines a heat conducting channel extending through said mold insert for conducting heat to the part to be molded, said heat conducting channel being in fluid communication with an inlet provided in the mold base for supplying heat to said heat conducting channel and with an outlet for allowing heat to escape from said heat conducting channel, when said mold insert is attached to the mold base.

58. The mold insert of claim 57, wherein said heat conducting channel is operable to allow steam supplied through the inlet on the mold base to circulate through said heat conducting channel and exit through the outlet on the mold base.

59. The mold insert of claim 58, which includes a plurality of air valves embedded in said first surface, said air valves being operable to protrude out of said first surface of said mold insert to separate the molded part from said first surface of said mold insert.

60. The mold insert of claim 55, wherein said air valves become operably connected to an air supply line provided on the receiving surface of the mold base when said mold insert is removably attached to the receiving surface of the mold base.

61. The mold insert of claim 55, wherein said mold insert defines a plurality of first through holes extending from said first surface to said second surface, said first through holes used to removably mount said mold insert to the mold base.

62. The mold insert of claim 61, wherein said first through holes are formed along a periphery of said mold insert.

63. The mold insert of claim 61, wherein said first through holes are countersunk at said first surface.

64. The mold insert of claim 61, wherein each of said first through holes enable a bolt to be passed through said through holes and threaded to the base to mount said mold insert to the mold base.

65. The mold insert of claim 61, which defines a plurality of second through holes which are threaded and extending from said first surface to said second surface, said second through holes being operable to detach said mold insert from the mold base when a bolt is threaded through said second through holes and against the surface of the mold base on which said mold insert is mounted.

66. The mold insert of claim 61, wherein said first through holes are threaded to operably receive a threaded bolt for cooperatively enabling said mold insert to be detached from the mold base.

67. A mold insert configured to be removably attached to a mold base mounted to a press in a compression molding apparatus for forming a molded part, said mold insert comprising:
a body;
a first surface of the body defining a cavity for forming a molded part in a desired shape;
a second surface of the body opposite the first surface and adapted to be removably attached to a receiving surface of the mold base; and
a heat conducting channel defined by and extending through said mold insert, wherein said heat conducting channel is configured to be in fluid communication with a heat inlet provided in the mold base for supplying heat to said heat conduction channel and with a heat outlet for allowing heat to escape from said heat conducting channel, when said mold insert is attached to the mold base.

68. The mold insert of claim 67, wherein said heat conducting channel allows steam supplied through the inlet on the mold base to circulate through said conducting channel and exit through the outlet on the mold base.

69. A mold insert configured to be removably attached to a mold base which is mounted to a press in a compression molding apparatus for forming a molded part, said mold insert comprising:
a body;
a first surface of the body defining a cavity for forming a molded part in a desired shape;
a second surface of the body opposite the first surface and adapted to be removably attached to a receiving surface of the mold base; and
a plurality of air valves embedded in said first surface, said air valves being operable to protrude out of said first surface of said mold insert to separate the molded part from said mold insert, wherein said air valves are in communication with an air supply line provided on the receiving surface of the mold base when said mold insert is removably mounted to the receiving surface of the mold base.

70. A method of making a plurality of different compression molded parts, said method comprising:
(a) removably attaching a first top mold insert for a first part to a top mold base connected to a press, which includes aligning at least one of a key and a lock of the first top mold insert with a coacting key or lock of the top mold base;
(b) removably attaching a first bottom mold insert for said first part in a bottom mold base connected to said press, which includes aligning at least one of a key and a lock of the first bottom mold insert with a coacting key or lock of the bottom mold base;
(c) compressing molding at least one of the first parts with the press;
(d) removing the first top mold insert from the top mold base and removing the first bottom mold insert from the bottom mold base;
(e) removably attaching a second top mold insert for a second part in the top base connected to the press, which includes aligning at least one of a key and a lock of the second top mold insert with a coacting key or lock of the top mold base;
(f) removably attaching a second bottom mold insert for said second part in the bottom mold base connected to said press, which includes aligning at least one of a key and a lock of the second bottom mold insert with a coacting key or lock of the bottom mold base; and
(g) compressing molding at least one of the second components with the press.

71. A method for compression molding a molded part, said method comprising the steps of:
removably mounting a first insert to a receiving surface of a first mold base, said receiving surface having one of a key and a lock fixedly formed on said receiving surface, said first insert having an attachment surface facing said receiving surface and having the other of said key or said lock for operably aligning said first insert to said first mold base, said first insert having a cavity surface opposite said attachment surface;
removably mounting a second insert to a receiving surface of a second mold base, said second insert having an attachment surface opposite said receiving surface of said second mold base for attachment to said receiving surface of said second mold base, and a cavity surface opposite said attachment surface of said second insert;
placing molding material for the part to be molded between said first and second inserts; and
pressing said first and second mold bases together to compression mold the part to be molded between said first and second mold inserts.

72. The method of claim 71, wherein one of a key or a lock is on said receiving surface of said second mold base, and the other of said key or said lock is on said attachment surface of said second insert, and which includes inserting said key into said lock to operably align said second insert to said second mold base when said second insert is being mounted to said second mold base.

73. A method of making a plurality of different compression molded parts, said method comprising:
(a) removably attaching a first top mold insert for a first part to a top mold base connected to a press;
(b) removably attaching a first bottom mold insert for said first part in a bottom mold base connected to said press;
(c) transferring heat from said top mold base to said first top mold insert and from said bottom mold base to said first bottom mold insert;
(d) compressing molding at least one of the first parts with the press;
(e) removing the first top mold insert from the top mold base and removing the first bottom mold insert from the bottom mold base;
(f) removably attaching a second top mold insert for a second part in the top base connected to the press;
(g) removably attaching a second bottom mold insert for said second part in the bottom base connected to said press;
(h) transferring heat from said top mold base to said second top mold insert and from said bottom mold base to said second bottom mold insert; and
(i) compressing molding at least one of the second parts with the press.

74. A method for heating a part to be molded in a compression molding apparatus having mold inserts which are removably mounted to opposing pair of mold bases which are connected to a press for compressing the part, said method comprising:
supplying heat from heat inlets which extend through the mold bases and to inlets of heat conducting channels in the mold inserts to heat the mold inserts to allow the heat to be transferred to the part to be molded; and
allowing the heat in the heat conducting channels to escape through outlets of said heat conducting channels to heat inlets which extend through the mold bases.

75. A method of making a plurality of different compression molded parts, said method comprising:
(a) removably attaching a first top mold insert for a first part to a top mold base connected to a press;
(b) removably attaching a first bottom mold insert for said first part in a bottom mold base connected to said press, which includes aligning at least one air inlet in the first bottom mold insert with one of a plurality of air outlets in the bottom mold base;
(c) compressing molding at least one of the first parts with the press;
(d) removing the first top mold insert from the top mold base and removing the first bottom mold insert from the bottom mold base;
(e) removably attaching a second top mold insert for a second part in the top base connected to the press;
(f) removably attaching a second bottom mold insert for said second part in the bottom mold base connected to said press, which includes aligning at least one air inlet in the second bottom mold insert with at least one different one of the plurality of air outlets in the bottom mold base; and
(g) compressing molding at least one of the second parts with the press.

76. A method for separating a part molded in a compression molding process from a first mold insert and a second mold insert complement to the first mold insert and for forming the molded part in a compression molding apparatus, wherein the compression molding apparatus has the first and the second mold inserts removably mounted to a first mold base and a second mold base that are connected to a press for compressing the part, said method comprising the steps of:
supplying air through at least one air line extending through the first mold base, wherein said first mold base defines a plurality of air holes extending from said air lines to a receiving surface of the first mold base, to enable at least one air operated valve embedded in the first mold insert to project out of said surface and push against the molded part; and
supplying air through at least one air line extending through the second mold base, wherein said second mold base defines a plurality of air holes extending from said air lines to a receiving surface of the second mold base, to enable at least one air operated valve embedded in the first mold insert to project out of said surface and push against the molded part.

77. A method for detaching a removable mold insert mounted to a mold base which is connected to a press in a compression molding apparatus, said method comprising the steps of:
removing attachment members which attach the mold insert to the mold base from a plurality of threaded through holes, wherein said threaded through holes extend from a first surface of the mold insert having a cavity for shaping the part to a second surface opposite said first surface for being operably attached to a mold insert receiving surface of the mold base; and
threading detachment members in the threaded through holes and tightening the mounting members against the mold base to which the mold insert is attached to cause the mold insert to separate from the surface of the mold base.

78. A method of making a compression molded part, said method comprising:
(a) removably attaching a top mold insert for part in a top mold base connected to a press;
(b) removably attaching a bottom mold inset for said part in a bottom mold base connected to said press opposite the top mold base; and
(c) compressing molded the part with the press which includes causing a plurality of alignment blocks attached to one of the top and bottom mold bases to engage the mold insert attached to the opposite mold base.
